(19) United States
(12) Patent Application Publication
(10) Pub. No.: US 2025/0349833 A1
(43) Pub. Date: Nov. 13, 2025

(54) ELECTRODE ASSEMBLY AND RECHARGEABLE BATTERY WITH THE SAME

(71) Applicant: SAMSUNG SDI CO., LTD., Gyeonggi-do (KR)

(72) Inventors: Woosung CHOI, Gyeonggi-do (KR); Haeju KIM, Gyeonggi-do (KR); Seung-Young PARK, Gyeonggi-do (KR); Jaegyun DOO, Gyeonggi-do (KR); Meenkyoung JUNG, Gyeonggi-do (KR); Dongjin AN, Gyeonggi-do (KR)

(73) Assignee: SAMSUNG SDI CO., LTD., Gyeonggi-do (KR)

(21) Appl. No.: 18/809,996

(22) Filed: Aug. 20, 2024

(30) Foreign Application Priority Data
May 10, 2024 (KR) 10-2024-0062167

(51) Int. Cl. H01M 4/36; H01M 4/02; H01M 4/48; H01M 4/587; H01M 4/62; H01M 10/04; H01M 50/105; H01M 50/107; H01M 50/152

(52) U.S. Cl. CPC H01M 4/366; H01M 4/48; H01M 4/587; H01M 4/625; H01M 10/0431; H01M 50/105; H01M 50/107; H01M 50/152; H01M 2004/027

(57) ABSTRACT

An electrode assembly of a rechargeable battery includes a separator, and a positive electrode and a negative electrode with the separator interposed therebetween, the positive electrode and the negative electrode being wound together with the separator. The negative electrode may include a negative substrate, a first active material layer disposed on one surface of the negative substrate, and a second active material layer disposed on the other surface of the negative substrate. The first active material layer may include a carbon-based active material, a silicon-based active material, and a carbon nanotube. The second active material layer may include the carbon-based active material.

### CROSS-REFERENCE TO RELATED APPLICATION

This application claims the benefit of priority to Korean Patent Application No. 10-2024-0062167 filed in the Korean Intellectual Property Office on May 10, 2024, the entire contents of which are incorporated herein by reference.

### BACKGROUND OF THE INVENTION

### (a) Field of the Invention

The present disclosure relates to a rechargeable battery, and more particularly, to a rechargeable battery with a wound type electrode assembly.

### (b) Description of the Related Art

A rechargeable battery may be used for a variety of purposes, including as a power source for small electronic devices such as, e.g., a mobile phone, a laptop computer, and the like, and as a power source for, e.g., driving a motor in an electric vehicle, a hybrid vehicle, or the like. The rechargeable battery may include a wound-type electrode assembly. The wound-type electrode assembly may include a positive electrode and a negative electrode with a separator interposed therebetween, the positive electrode and the negative electrode being together with the separator.

In a lithium rechargeable battery, a negative active material layer may include a carbon-based active material and/or a silicon-based active material. The negative active material layer may undergo a volume change, in which the negative active material layer expands when charged, and contracts when discharged. Although effectively increasing a capacity of the negative electrode, the silicon-based active material may undergo a larger volume change than the carbon-based active material when the rechargeable battery is charged or discharged, which may cause a rupture and thus reduce a reversible capacity.

### SUMMARY OF THE INVENTION

Examples of the present disclosure include an electrode assembly in which a rupture and resulting capacity reduction are hindered or prevented by reducing or suppressing a volume change of a silicon-based active material while increasing a capacity of a negative electrode. Examples of the disclosure also include a rechargeable battery with the electrode assembly discussed above.

According to an example embodiment, an electrode assembly includes a separator, and a positive electrode and a negative electrode with the separator interposed therebetween, the positive electrode and the negative electrode being wound together with the separator. The negative electrode includes a negative substrate, a first active material layer disposed on one surface of the negative substrate, and a second active material layer disposed on the other surface of the negative substrate. A content of a silicon-based active material in the first active material layer and a content of the silicon-based active material in the second active material layer are different from each other.

The first active material layer may include a carbon-based active material and the silicon-based active material, and the second active material layer may include the carbon-based active material. The second active material layer may further include the silicon-based active material, and the content of the silicon-based active material in the first active material layer may be greater than the content of the silicon-based active material in the second active material layer.

The first active material layer may further include a carbon nanotube, e.g., as a conductive material. The second active material layer may further include the carbon nanotube, e.g., as the conductive material, and a content of the carbon nanotube in the first active material layer may be greater than a content of the carbon nanotube in the second active material layer.

According to another example embodiment, an electrode assembly includes a separator, and a positive electrode and a negative electrode with the separator interposed therebetween, the positive electrode and the negative electrode being wound together with the separator. The negative electrode includes a negative substrate, a first active material layer disposed on one surface of the negative substrate, and a second active material layer disposed on the other surface of the negative substrate. The first active material layer includes a carbon-based active material, a silicon-based active material, and a carbon nanotube, e.g., as a conductive material, and the second active material layer includes the carbon-based active material.

The second active material layer may further include the silicon-based active material, and a content of the silicon-based active material in the first active material layer may be greater than a content of the silicon-based active material in the second active material layer. The second active material layer may further include the carbon nanotube, e.g., as the conductive material, and a content of the carbon nanotube in the first active material layer may be greater than a content of the carbon nanotube in the second active material layer.

The active material in the first active material layer may include about 80 to about 98% by weight of the carbon-based active material and about 2 to about 20% by weight of the silicon-based active material, and the first active material layer may include about 0.01 to about 0.1 parts by weight of the carbon nanotube for 100 parts by weight of the active material. The active material in the second active material layer may include about 98% to about 100% by weight of the carbon-based active material and about 2% by weight or less of the silicon-based active material. The second active material layer may include about 0.01 parts by weight or less of the carbon nanotube for about 100 parts by weight of the active material.

The first active material layer may be disposed on the one surface of the negative substrate that faces the inside of the electrode assembly, and the second active material layer may be disposed on the other surface of the negative substrate that faces the outside of the electrode assembly. The positive electrode may include a positive substrate, a third active material layer disposed on one surface of the positive substrate that faces the inside of the electrode assembly, and a fourth active material layer disposed on the other surface of the positive substrate that faces the outside of the electrode assembly.

The first active material layer and the second active material layer may have the same loading level, and a loading level of the fourth active material layer may be greater than a loading level of the third active material layer. Alternatively, the third active material layer and the fourth active material layer may have the same loading level, and a loading level of the first active material layer may be smaller than a loading level of the second active material layer. The loading level represents a weight of the active material per unit area.

Alternatively, the first active material layer may be disposed on the one surface of the negative substrate that faces the outside of the electrode assembly, and the second active material layer may be disposed on the other surface of the negative substrate that faces the inside of the electrode assembly. The positive electrode may include a positive substrate, a third active material layer disposed on one surface of the positive substrate that faces the inside of the electrode assembly, and a fourth active material layer disposed on the other surface of the positive substrate that faces the outside of the electrode assembly.

The first active material layer and the second active material layer may have the same loading level, and a loading level of the third active material layer may be greater than a loading level of the fourth active material layer. Alternatively, the third active material layer and the fourth active material layer may have the same loading level, and a loading level of the first active material layer may be smaller than a loading level of the second active material layer.

According to an example embodiment, a rechargeable battery includes an electrode assembly, a cylindrical case that encloses the electrode assembly in an internal space, and a cap plate that is coupled to an open end of the case and seals the case. The electrode assembly may have a jelly roll shape.

According to an example embodiment, a rechargeable battery includes an electrode assembly, and a pouch-type case that encloses and seals the electrode assembly. The electrode assembly may include a flat central part, and a pair of round parts disposed on both sides of the central part and each having a curvature.

As set forth above, the electrode assembly according to the example embodiments may be hindered or prevented from undergoing a rupture and any resulting capacity reduction by reducing or suppressing the volume change of the silicon-based active material in the first active material layer while increasing the capacity of the negative electrode due to the high content of the silicon-based active material in the first active material layer.

### BRIEF DESCRIPTION OF THE DRAWINGS

FIG. 1 is a perspective view of an electrode assembly according to a first example embodiment.

FIG. 2 is an exploded perspective view illustrating an unfolded state of the electrode assembly illustrated in FIG. 1.

FIG. 3 is an enlarged view of a portion of a cross section of the electrode assembly illustrated in FIG. 1 that is cut in a longitudinal direction thereof.

FIG. 4 is an enlarged view of a portion of a cross section of the electrode assembly illustrated in FIG. 1 that is cut in a direction substantially perpendicular to the longitudinal direction thereof.

FIG. 5 is an enlarged view of a portion of a cross section of an electrode assembly according to a second embodiment that is cut in the direction substantially perpendicular to the longitudinal direction thereof.

FIG. 6 is a perspective view of an electrode assembly according to a third example embodiment.

FIG. 7 is a perspective view of a rechargeable battery according to a fourth example embodiment.

FIG. 8 is a cross-sectional view of the rechargeable battery illustrated in FIG. 7.

FIG. 9 is an exploded perspective view of a rechargeable battery according to a fifth example embodiment.

### DETAILED DESCRIPTION OF THE EMBODIMENTS

Hereinafter, example embodiments of the present disclosure are described in detail with reference to the accompanying drawings so that those skilled in the art to which the present disclosure pertains may readily practice the present disclosure. The present disclosure may be implemented in various different forms and is not limited to the example embodiments described herein.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

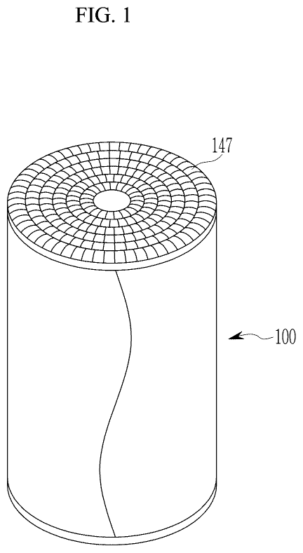

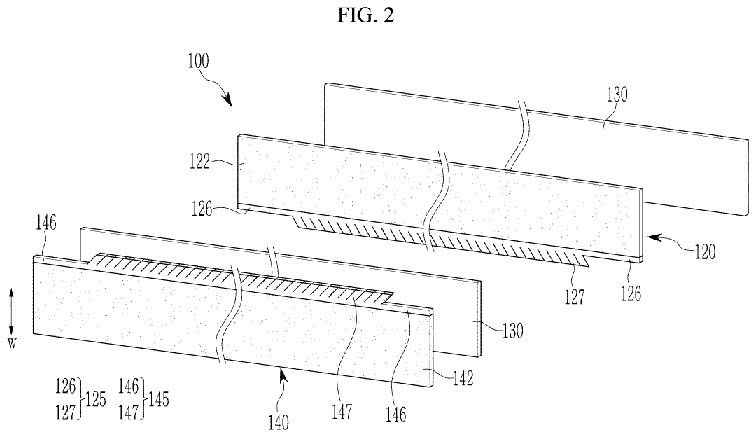

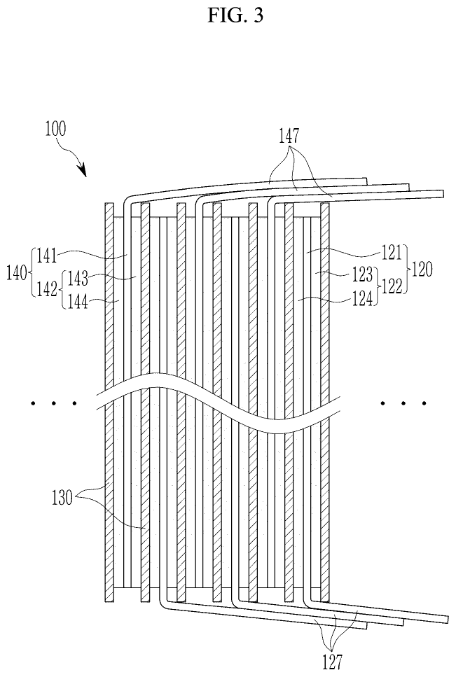

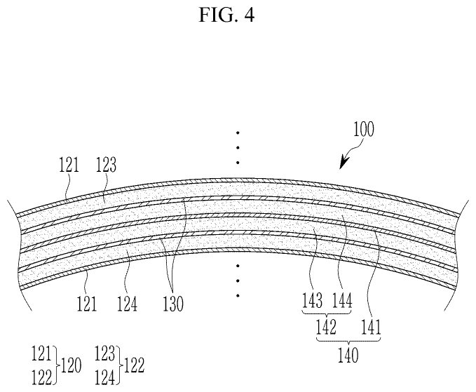

FIG. 1 is a perspective view of an electrode assembly according to a first example embodiment. FIG. 2 is an exploded perspective view showing an unfolded state of the electrode assembly illustrated in FIG. 1. FIG. 3 is an enlarged view of a portion of a cross section of the electrode assembly illustrated in FIG. 1 that is cut in a longitudinal direction thereof. FIG. 4 is an enlarged view of a portion of a cross section of the electrode assembly illustrated in FIG. 1 that is cut in a direction substantially perpendicular to the longitudinal direction thereof.

Referring to FIGS. 1 to 4, an electrode assembly 100 in this example embodiment may include a laminate including a positive electrode 120, a separator 130, and a negative electrode 140, and wound a plurality of times around a center pin (not shown). Each of the positive electrode 120, the separator 130, and the negative electrode 140 may have an elongated strip shape, and the laminate may be wound in the form of a jelly roll.

The laminate may be laminated in an order of, e.g., the negative electrode 140, the separator 130, the positive electrode 120, and the separator 130 from the inside facing the center pin. In examples, positions of the positive electrode 120 and the negative electrode 140 may be swapped. The center pin may be removed after winding the laminate, where an empty space may be provided at the center of the electrode assembly 100.

The positive electrode 120 may include a positive substrate 121 and a positive active material layer 122 disposed on at least one surface of the positive substrate 121. The positive substrate 121 may be referred to as a positive current collector. The positive substrate 121 may be made of or include aluminum or the like, and may have the form of a thin plate or foam. The positive active material layer 122 may include a positive active material, and selectively further include a binder and/or a conductive material.

The positive active material may include a lithium transition metal complex oxide. The lithium transition metal complex oxide may include, for example, at least one of lithium-nickel-based oxide, lithium-cobalt-based oxide, lithium-manganese-based oxide, lithium-iron phosphate-based compound, and cobalt-free lithium nickel-manganese-based oxide.

The negative electrode 140 may include a negative substrate 141 and a negative active material layer 142 disposed on at least one surface of the negative substrate 141. The negative substrate 141 may be referred to as a negative current collector. The negative substrate 141 may be made of or include copper, nickel, copper alloy, or nickel alloy, and may have the form of the thin plate or the foam. The negative active material layer 142 may include a negative active material, and may selectively further include the binder and/or the conductive material.

The negative active material may include at least one of a carbon-based active material and a silicon-based active material. The carbon-based active material may include at least one of natural graphite and artificial graphite. The silicon-based active material may include at least one of a silicon-carbon composite active material and silicon oxide (SiOx, 0<x≤2).

In each of, or in at least one of, the positive active material layer 122 and the negative active material layer 142, the binder may include at least one of an aqueous binder, a non-aqueous binder, and a dry binder. In each of, or in at least one of, the positive active material layer 122 and the negative active material layer 142, the conductive material may include at least one of a carbon-based material such as one or more of natural graphite, artificial graphite, carbon black, a carbon fiber, a carbon nanofiber, or a carbon nanotube; a metal material in the form of or including a metal powder or a metal fiber that includes one or more of copper, nickel, aluminum, silver, or the like; or a conductive polymer such as polyphenylene derivative.

The separator 130 may be made of or include a porous substrate, or at least a porous substrate having a coating layer disposed on at least one surface. The porous substrate may include at least one of polyethylene, polypropylene, polyethylene terephthalate, polypropylene terephthalate, polybutylene terephthalate, polyester, polycarbonate, and polyimide. The coating layer may include the binder, and the binder may include a polyvinylidene fluoride-based compound. The separator 130 may insulate the positive electrode and the negative electrode from each other while allowing movement of lithium ions.

In the positive electrode 120, the positive active material layer 122 may be disposed on the remaining portion of the positive substrate 121 except for an edge of one side (e.g., lower side). A portion of the positive substrate 121 that is not covered by the positive active material layer 122 and whose surface is exposed may be referred to as a positive uncoated region 125. In the negative electrode 140, the negative active material layer 142 may be disposed on a remaining portion of the negative substrate 141 except for an edge of the other side (e.g., upper side). A portion of the negative substrate 141 that is not covered by the negative active material layer 142 and the surface of which is exposed may be referred to as a negative uncoated region 145.

The positive uncoated region 125 may include a pair of edge uncoated regions 126 and a central uncoated region 127 disposed between the pair of edge uncoated regions 126. The negative uncoated region 145 may include a pair of edge uncoated regions 146 and a central uncoated region 147 disposed between the pair of edge uncoated regions 146. A height of the edge uncoated region 126, 146 that is measured in a width direction (W direction in FIG. 2) of the positive electrode 120 and the negative electrode 140 may be smaller than a height of the central uncoated region 127, 147.

The central uncoated region 127, 147 may be bent inward toward the winding center of the electrode assembly 100. A plurality of cutting lines may be disposed in the central uncoated region 127, 147 to facilitate bending of the central uncoated region 127, 147. Both sides of the central uncoated region 127, 147 and the plurality of cutting lines may be formed in a diagonal direction with respect to the width direction W, and are not limited to this example.

The central uncoated region 127 of the positive electrode 120 may be fixed to a positive current collector (not shown), and the central uncoated region 147 of the negative electrode 140 may be fixed to a negative current collector (not shown). The central uncoated regions 127 and 147, which are bent inward and overlap each other, may increase current collection efficiency of the positive electrode 120 and the negative electrode 140. In various examples, the electrode assembly 100, the positive current collector, and the negative current collector may be stored inside a case (not shown) together with an electrolyte.

Referring to FIG. 4, each of, or at least one of, the positive electrode 120, the negative electrode 140, and the separator 130, may have a predetermined or desired curvature. The negative active material layer 142 may include a first active material layer 143 disposed on one surface of the negative substrate 141, and a second active material layer 144 disposed on the other surface of the negative substrate 141.

The first active material layer 143 may be disposed on one surface of the negative substrate 141 that faces the center (inside) of the electrode assembly 100, and the second active material layer 144 may be disposed on the other surface of the negative substrate 141 that faces the outside of the electrode assembly 100. Due to the curvature of the negative electrode 140, a compressive stress may act on the first active material layer 143, and a tensile stress may act on the second active material layer 144.

The first active material layer 143 and the second active material layer 144 may have different contents of the silicon-based active material. In examples, the first active material layer 143 and the second active material layer 144 may have different contents of the carbon nanotube, which is or is included in the conductive material. The carbon nanotube, which is the conductive material, may reduce a resistance of the silicon-based active material in the first and second active material layer 143, 144, thus allowing the silicon-based active material to react smoothly with lithium. The carbon nanotube may include at least one of a single-walled carbon nanotube and a multi-walled carbon nanotube.

In examples, the content of the silicon-based active material included in the first active material layer 143 may be greater than the content of the silicon-based active material included in the second active material layer 144. In addition, the content of the carbon nanotube included in the first active material layer 143 may be greater than the content of the carbon nanotube included in the second active material layer 144.

The active material in the first active material layer 143 may include, for example, about 80% to about 98% by weight of the carbon-based active material and about 2% to about 20% by weight of the silicon-based active material. The first active material layer 143 may include about 0.01 to about 0.1 parts by weight of the carbon nanotube, which is the conductive material, for 100 parts by weight of the active material.

The active material in the second active material layer 144 may include, for example, about 98% to about 100% by weight of the carbon-based active material and about 2% by weight or less of the silicon-based active material. The second active material layer 144 may include about 0.01 parts by weight or less of the carbon nanotube for 100 parts by weight of the active material. The content of the silicon-based active material in the second active material layer 144 may be equal to 0, or about 2% or less and more than 0 by weight. The content of the carbon nanotube in the second active material layer 144 may be equal to 0, or more than 0 and about 0.01 parts or less by weight.

In each of the first active material layer 143 and the second active material layer 144, the carbon-based active material may include at least one of the natural graphite and the artificial graphite, for example, the artificial graphite. The artificial graphite may have higher durability than the natural graphite. The silicon-based active material may include at least one of the silicon-carbon composite active material and the silicon oxide (SiOx, 0<x≤2).

The silicon-carbon composite active material may include at least one of a first composite active material, a second composite active material, and a third composite active material. The first composite active material may include a plurality of silicon nanoparticles and an amorphous carbon coating layer disposed on a surface of the silicon nanoparticle. The second composite active material may include a core including a silicon-carbon composite and a polymer coating layer disposed on a surface of the core. The third composite active material may include a core including a silicon-based material and a carbon-based coating layer disposed on a surface of the core.

It may be difficult to implement capacity increase of the negative electrode when the content of the silicon-based active material in the first active material layer 143 is less than about 2% by weight, and it may become difficult to reduce or suppress volume expansion of the first active material layer 143 when the content of the silicon-based active material is more than about 20% by weight. The first active material layer 143 may be a poor conductive material when the content of the carbon nanotube is less than about 0.01 parts by weight, and may have a reduced capacity of the negative electrode 140 as the active material content in the first active material layer 143 is relatively reduced when the content of the carbon nanotube is more than about 0.1 parts by weight.

The second active material layer 144 receiving the tensile stress may have a substantial volume expansion when the content of the silicon-based active material in the second active material layer 144 is more than about 2% by weight. The second active material layer 144 may have a reduced capacity of the negative electrode 140 as the active material content in the second active material layer 144 is relatively reduced when the content of the carbon nanotube is more than about 0.01 parts by weight.

The first active material layer 143 or the second active material layer 144 may further include the binder. The binder may increase an adhesive strength between the negative substrate 141 and the first and second active material layer 143, 144, and increase an adhesive strength between the carbon-based active material and the silicon-based active material and/or the conductive material. The binder of the first active material layer 143 and the binder of the second active material layer 144 may be of the same or similar type, or of different types. An appropriate content may be determined based on a binder type.

The binder may include, for example, at least one of polyvinyl alcohol, carboxymethylcellulose, hydroxypropylcellulose, diacetylcellulose, polyvinyl chloride, polyurethane, polyethylene, polypropylene, epoxy resin, (meth)acrylic resin, polyester resin, or nylon, and is not limited to such an example. The binder of the first active material layer 143 may include a material that assists in increasing a mechanical strength of the first active material layer 143. The binder of the second active material layer 144 may include a material that is advantageous in increasing the electrical conductivity and ionic conductivity of the second active material layer 144.

In general, a capacity per mass of the silicon-based active material may be greater than a capacity per mass of the carbon-based active material. Although effectively increasing the capacity of the negative electrode, the silicon-based active material may undergo a larger volume change than the carbon-based active material when the electrode assembly is charged or discharged, which may cause a rupture and thus reduce a reversible capacity.

In this example embodiment, the first active material layer 143 may include a silicon-based active material having a higher content than the second active material layer 144, which may contribute to increasing the capacity of the negative electrode 140. In addition, the compressive stress acting on the first active material layer 143 may reduce or suppress the volume change of the silicon-based active material in the first active material layer 143. Therefore, the electrode assembly 100 in this example embodiment may be hindered or prevented from undergoing a rupture or a capacity reduction by reducing or suppressing the volume change of the silicon-based active material in the first active material layer 143 by the compressive stress applied to the first active material layer 143 while increasing the capacity of the negative electrode 140 due to the higher content of the silicon-based active material in the first active material layer 143.

The negative electrode 140 configured as described above may be readily manufactured. For example, the negative 140 may be manufactured through a process of respectively producing a first slurry for the first active material layer 143 and a second slurry for the second active material layer 144, applying the first slurry to one surface of the negative substrate 141, applying the second slurry to the other surface of the negative substrate 141, and drying and compressing the applied first and second slurries.

At least one of the first active material layer and the second active material layer includes two or more layers having different silicon contents as a configuration for achieving the same goal as the negative electrode 140 configured as described above. In an example, it may be advantageous to use a plurality of coating nozzles to respectively apply two or more layers, which may require an increased technical difficulty and a complicated negative electrode production process. On the other hand, the negative electrode 140 configured as described above may be readily manufactured and advantageous for mass production.

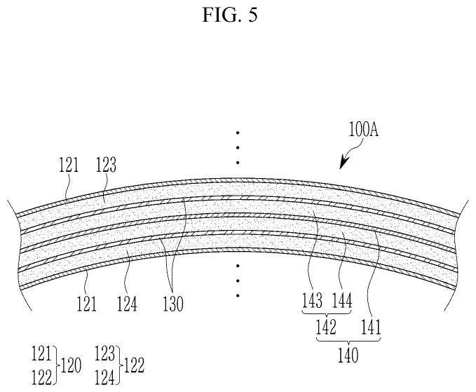

FIG. 5 is an enlarged view of a portion of a cross section of an electrode assembly according to a second example embodiment that is cut in the direction substantially perpendicular to the longitudinal direction thereof.

Referring to FIG. 5, in an electrode assembly 100A in this example embodiment, the first active material layer 143 may be disposed on one surface of the negative substrate 141 that faces the outside of the electrode assembly 100A, and the second active material layer 144 may be disposed on the other surface of the negative substrate 141 that faces the center (inside) of the electrode assembly 100A. Each of, or at least one of, the first active material layer 143 and the second active material layer 144 may be the same as each of, or at least one of, the first active material layer 143 and the second active material layer 144 described in the first example embodiment, and the description thus omits the description thereof.

The compressive stress may act on the second active material layer 144, and the tensile stress may act on the first active material layer 143, due to the curvature of the negative electrode 140. The first active material layer 143 may have a lower density per unit volume due to the curvature and the tensile stress compared to a case without the curvature. The lower density of the first active material layer 143 may be configured to absorb the volume expansion of the first active material layer 143 when the electrode assembly is charged or discharged, thus reducing or suppressing the volume change of the first active material layer 143. In addition, the lower density of the first active material layer 143 may increase the output of a rechargeable battery by facilitating the movement of lithium through the electrolyte.

In the first and second example embodiments described above, the first active material layer 143 and the second active material layer 144 may have different capacities per unit mass due to differences in their compositions. For example, the capacity per unit mass of the first active material layer 143 may be greater than the capacity per unit mass of the second active material layer 144. A loading level of the first active material layer 143 may be equal to or less than a loading level of the second active material layer 144.

The positive active material layer 122 may include a third active material layer 123 disposed on one surface of the positive substrate 121 that faces the center (inside) of the electrode assembly 100, 100A, and a fourth active material layer 124 disposed on the other surface of the positive substrate 121 that faces the outside of the electrode assembly 100, 100A.

Referring to FIG. 4, in the electrode assembly 100 according to the first example embodiment, the first active material layer 143 may face the fourth active material layer 124 while having the separator 130 interposed therebetween, and the second active material layer 144 may face the third active material layer 123 while having the separator 130 interposed therebetween. Referring to FIG. 5, in the electrode assembly 100A according to the second example embodiment, the first active material layer 143 may face the third active material layer 123 while having the separator 130 interposed therebetween, and the second active material layer 144 may face the fourth active material layer 124 while having the separator 130 interposed therebetween.

Referring to FIG. 4, the first active material layer 143 and the second active material layer 144 may have the same or a similar loading level. In this case, the loading level of the fourth active material layer 124 facing the first active material layer 143 may be greater than the loading level of the third active material layer 123 facing the second active material layer 144. On the other hand, the third active material layer 123 and the fourth active material layer 124 may have the same loading level. In this case, the loading level of the first active material layer 143 may be smaller than the loading level of the second active material layer 144.

In both the cases described above, the capacity ratio between anode and cathode (N/P ratio) of the positive electrode 120 and the negative electrode 140 may be equalized by matching an N/P ratio of the first active material layer 143 and the fourth active material layer 124 and an N/P ratio of the second active material layer 144 and the third active material layer 123 to the same as each other. The N/P ratio is a capacity per unit area of the negative electrode 140 divided by a capacity per unit area of the positive electrode 120, and may have a value greater than 1.

Referring to FIG. 5, the first active material layer 143 and the second active material layer 144 may have the same loading level. In this case, the loading level of the third active material layer 123 facing the first active material layer 143 may be greater than the loading level of the fourth active material layer 124 facing the second active material layer 144. On the other hand, the third active material layer 123 and the fourth active material layer 124 may have the same loading level. In this case, the loading level of the first active material layer 143 may be smaller than the loading level of the second active material layer 144.

In both the cases described above, the N/P ratio of the positive electrode 120 and the negative electrode 140 may be equalized by matching the N/P ratio of the first active material layer 143 and the fourth active material layer 124 and the N/P ratio of the second active material layer 144 and the third active material layer 123 to the same as each other.

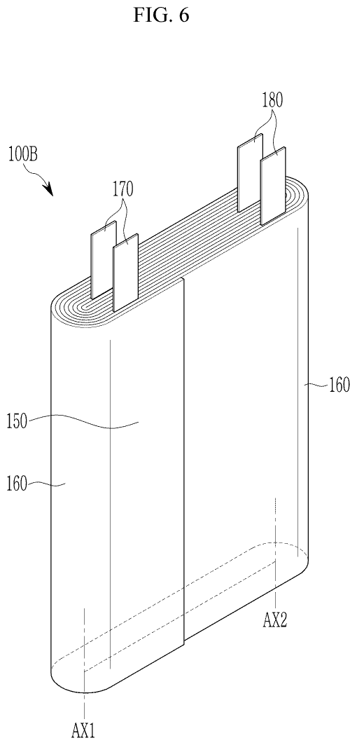

FIG. 6 is a perspective view of an electrode assembly according to a third example embodiment.

Referring to FIG. 6, an electrode assembly 100B in this example embodiment may include a laminate including the positive electrode, the separator, and the negative electrode, wound around two winding axes AX1 and AX2, and subsequently pressed to be flat. In examples, the electrode assembly 100B may include a flat square central part 150 and a pair of round parts 160 disposed on both sides of the central part 150. The central part 150 may be a flat part having a certain or desired thickness and disposed between the first winding axis AX1 and the second winding axis AX2. The pair of round parts 160 may be semicircular curved parts respectively surrounding the two winding axes AX1 and AX2.

The positive electrode may include at least one positive tab 170, and the negative electrode may include at least one negative tab 180. The positive tab 170 and the negative tab 180 may extend toward one side (e.g., upper side) of the electrode assembly 100B. In another example, the positive tab 170 may extend toward one side of the electrode assembly when the negative tab 180 extends toward an opposite side of the electrode assembly. FIG. 6 illustrates the example where the positive tab 170 and the negative tab 180 extend toward the same side.

The electrode assembly 100B in this example embodiment has the same or similar configuration as any of the first example embodiment and the second example embodiment described above, with a difference that the electrode assembly 100B is wound flat.

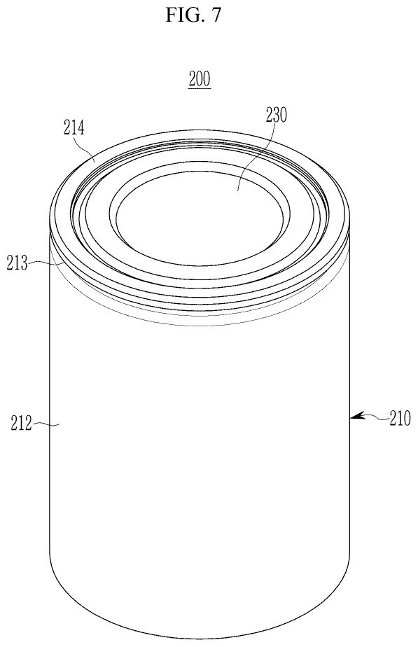

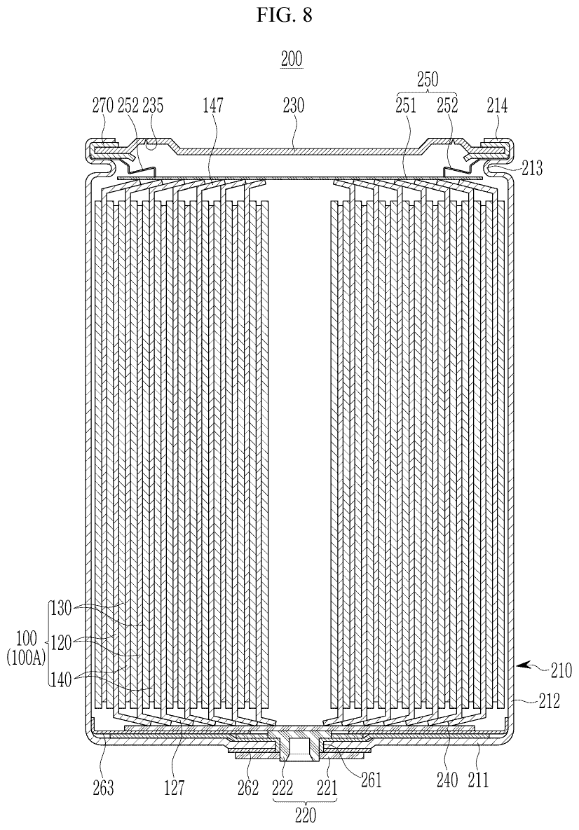

FIG. 7 is a perspective view of a rechargeable battery according to a fourth example embodiment. FIG. 8 is a cross-sectional view of the rechargeable battery illustrated in FIG. 7.

Referring to FIGS. 7 and 8, a rechargeable battery 200 according to this example embodiment may be a cylindrical rechargeable battery. The rechargeable battery 200 may include a cylindrical case 210, the electrode assembly 100 or 100A encloses inside the case 210, a terminal part 220 disposed on one side (e.g., lower side) of the case 210, and a cap plate 230 disposed on the other side (e.g., upper side) of case 210.

The electrode assembly 100 or 100A may be the electrode assembly in any of the first example embodiment and the second example embodiment described above. A positive current collector 240 may be disposed on one side (e.g., lower side) of the electrode assembly 100 or 100A, and negative current collector 250 may be disposed on the other side (e.g., upper side) of the electrode assembly 100 or 100A. The positive current collector 240 may be fixed to the central uncoated region 127 of the positive electrode 120 by, e.g., welding or another method. The negative current collector 250 may be fixed to the central uncoated region 147 of the negative electrode 140 by, e.g., welding or another method.

The case 210 may include a disk-shaped bottom part 211 and a cylindrical side part 212 extending upward from an edge of the bottom part 211. The case 210 may be made of or include, for example, at least one of steel, aluminum, or an aluminum alloy. When the top and bottom of the rechargeable battery 200 are swapped, the bottom part 211 may be referred to as a top part. The electrode assembly 100 or 100A and the positive and the negative current collector 240, 250 may be enclosed in an internal space of the case 210 together with the electrolyte.

A terminal hole may be disposed in the center of the bottom part 211, and the terminal part 220 may be installed in the terminal hole. The terminal part 220 may include a first terminal 221 that has a disk shape, and a second terminal 222 that has a roughly cylindrical shape. The first terminal 221 may be disposed on the outside (e.g., lower side) of the bottom part 211, and the second terminal 222 may be inserted into the terminal hole. The second terminal 222 may be coupled to the first terminal 221 and the bottom part 211 by riveting.

The second terminal 222 may be coupled to the positive current collector 240, and the terminal part 220 may be charged to have the same polarity as the positive electrode 120 to thus constitute a positive terminal. First to third insulators 261, 262, and 263 may be disposed between the case 210 and the terminal part 220 to insulate the case 210 and the terminal part 220 from each other.

A beading part 213 and a crimping part 214 may be disposed on the side part 212 of the case 210. The beading part 213 may be a part concavely deformed toward the inside of the case 210, and the crimping part 214 may be a part where an upper end of the side part 212 is bent toward the inside of the case 210. The electrode assembly 100 or 100A may be enclosed in a space between the bottom part 211 and the beading part 213, and movement thereof may be reduced or suppressed inside the case 210 by the beading part 213.

The negative current collector 250 may include a main body 251 and a plurality of connectors 252 extending downward from an edge of the main body 251. The plurality of connectors 252 may be in contact with the beading part 213, and fixed to the beading part 213 by a method such as, e.g., welding. The case 210 may be charged to have the same polarity as the negative electrode 140 by the negative current collector 250 to thus constitute a negative terminal.

As another example, although not shown, the negative current collector may be coupled to the terminal part, and the positive current collector may include the connector and fixed to the beading part. In this case, the case may constitute the positive terminal, and the terminal part may constitute the negative terminal.

The cap plate 230 may be disposed on the outside (upper side) of the negative current collector 250, and an edge of the cap plate 230 may be fixed between the beading part 213 and the crimping part 214 via an insulating gasket 270. The cap plate 230 and the insulating gasket 270 may seal the case 210, and the cap plate 230 may be electrically non-polar. A notch groove 235 may be disposed in at least one surface of the cap plate 230. The notch groove 235 may have a V-shaped cross section, and may be arc-shaped on a bottom portion thereof, e.g., when viewing a target object from below.

An internal temperature of the rechargeable battery 200 may be increased due to various causes such as, e.g., rapid charging and discharging, external impact, and exposure to a high temperature environment, and an internal pressure of the rechargeable battery 200 may be increased due to, e.g., vaporization of the electrolyte. When the internal pressure of the rechargeable battery 200 is increased, the cap plate 230 may rupture from the notch groove 235 to discharge an internal gas.

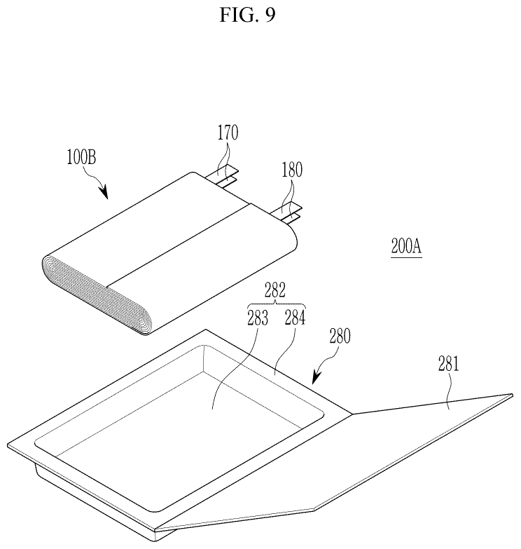

FIG. 9 is an exploded perspective view of a rechargeable battery according to a fifth example embodiment.

Referring to FIG. 9, a rechargeable battery 200A in this example embodiment may be a pouch-type rechargeable battery. The rechargeable battery 200A may include the electrode assembly 100B and a case 280 configured to accommodate and seal the electrode assembly 100B therein. The case 280 may be referred to as a pouch, and the electrode assembly 100B may be or include the electrode assembly in the third example embodiment described above.

The case 280 may include an upper case 281 and a lower case 282. The lower case 282 may include a storage part 283, which is a concave space for accommodating the electrode assembly 100B therein, and a sealing part 284 which surrounds the storage part 283. The electrode assembly 100B may be enclosed in the storage part 283, and the upper case 281 may be folded to overlap the lower case 282 and the electrode assembly 100B enclosed therein. An edge of the upper case 281 may be joined to the sealing part 284 by a joining method such as, e.g., heat fusion.

Each of, or one of, the upper case 281 and the lower case 282 may have a multilayer structure of metal sheets and polymer sheets. The metal sheet may be or include an aluminum sheet, and may provide mechanical strength to the case 280. The polymer sheet may include, e.g., at least one of a polyethylene terephthalate (PET) sheet, a nylon sheet, a PET-nylon composite sheet, or the like, and provide insulation and protection to the case 280. The metal sheet may be disposed between at least two polymer sheets.

A portion of the positive tab 170 and a portion of the negative tab 180 may overlap the sealing part 284, and an end of the positive tab 170 and an end of the negative tab 180 may protrude to the outside of the sealing part 284. A protective tape (not shown) may be disposed on a portion of the positive tab 170 and the negative tab 180 that overlaps the sealing part 284.

Although the example embodiments of the present disclosure have been described hereinabove, the scope of the present disclosure is not limited thereto. Various modifications may be implemented within the scope of the patent claims, detailed description, and attached drawings of the present disclosure, which also fall within the spirit and scope of the present disclosure.

What is claimed is:

1. An electrode assembly comprising:
a separator; and
a positive electrode and a negative electrode with the separator interposed therebetween, the positive electrode and the negative electrode being wound together with the separator,
wherein the negative electrode includes a negative substrate, a first active material layer on one surface of the negative substrate, and a second active material layer on the other surface of the negative substrate, and
a content of a silicon-based active material in the first active material layer and a content of the silicon-based active material in the second active material layer are different from each other.

2. The electrode assembly of claim 1, wherein:
the first active material layer includes a carbon-based active material and the silicon-based active material, and
the second active material layer includes the carbon-based active material.

3. The electrode assembly of claim 2, wherein:
the second active material layer further includes the silicon-based active material, and
the content of the silicon-based active material in the first active material layer is greater than the content of the silicon-based active material in the second active material layer.

4. The electrode assembly of claim 3, wherein the first active material layer further includes a carbon nanotube.

5. The electrode assembly of claim 4, wherein:
the second active material layer further includes the carbon nanotube, and
a content of the carbon nanotube in the first active material layer is greater than a content of the carbon nanotube in the second active material layer.

6. An electrode assembly comprising:
a separator; and
a positive electrode and a negative electrode with the separator interposed therebetween, the positive electrode and the negative electrode being wound together with the separator,
the negative electrode includes a negative substrate, a first active material layer on one surface of the negative substrate, and a second active material layer on the other surface of the negative substrate,
the first active material layer includes a carbon-based active material, a silicon-based active material, and a carbon nanotube, and
the second active material layer includes the carbon-based active material.

7. The electrode assembly of claim 6, wherein:
the second active material layer further includes the silicon-based active material, and
a content of the silicon-based active material in the first active material layer is greater than a content of the silicon-based active material in the second active material layer.

8. The electrode assembly of claim 7, wherein:
the second active material layer further includes the carbon nanotube, and
a content of the carbon nanotube in the first active material layer is greater than a content of the carbon nanotube in the second active material layer.

9. The electrode assembly of claim 7, wherein:
the active material in the first active material layer includes about 80% to about 98% by weight of the carbon-based active material and about 2% to about 20% by weight of the silicon-based active material, the first active material layer includes about 0.01 to about 0.1 parts by weight of the carbon nanotube for 100 parts by weight of the active material, and
the active material in the second active material layer includes about 98% to about 100% by weight of the carbon-based active material and about 2% by weight or less of the silicon-based active material.

10. The electrode assembly of claim 9, wherein the second active material layer includes about 0.01 parts by weight or less of the carbon nanotube for 100 parts by weight of the active material.

11. The electrode assembly of claim 6, wherein the first active material layer is on the one surface of the negative substrate that faces the inside of the electrode assembly, and the second active material layer is on the other surface of the negative substrate that faces the outside of the electrode assembly.

12. The electrode assembly of claim 11, wherein the positive electrode includes a positive substrate, a third active material layer on one surface of the positive substrate that faces the inside of the electrode assembly, and a fourth active material layer on the other surface of the positive substrate that faces the outside of the electrode assembly.

13. The electrode assembly of claim 12, wherein:
the first active material layer and the second active material layer have a same loading level, and
a loading level of the fourth active material layer is greater than a loading level of the third active material layer.

14. The electrode assembly of claim 12, wherein:
the third active material layer and the fourth active material layer have a same loading level, and
a loading level of the first active material layer is smaller than a loading level of the second active material layer.

15. The electrode assembly of claim 6, wherein the first active material layer is on the one surface of the negative substrate that faces the outside of the electrode assembly, and the second active material layer is on the other surface of the negative substrate that faces the inside of the electrode assembly.

16. The electrode assembly of claim 15, wherein the positive electrode includes a positive substrate, a third active material layer on one surface of the positive substrate that faces the inside of the electrode assembly, and a fourth active material layer on the other surface of the positive substrate that faces the outside of the electrode assembly.

17. The electrode assembly of claim 16, wherein:
the first active material layer and the second active material layer have a same loading level, and
a loading level of the third active material layer is greater than a loading level of the fourth active material layer.

18. The electrode assembly of claim 16, wherein:
the third active material layer and the fourth active material layer have a same loading level, and
a loading level of the first active material layer is smaller than a loading level of the second active material layer.

19. A rechargeable battery comprising:
the electrode assembly of claim 1;
a cylindrical case that encloses the electrode assembly in an internal space thereof; and
a cap plate coupled to an open end of the case and that seals the case,
wherein the electrode assembly has a jelly roll shape.

20. A rechargeable battery comprising:
the electrode assembly of claim 1; and
a pouch-type case that encloses and seals the electrode assembly,
wherein the electrode assembly includes a flat central part and a pair of round parts on both sides of the central part, each round part having a curvature.
